(19) United States
(12) Patent Application Publication
(10) Pub. No.: US 2022/0266633 A1
(43) Pub. Date: Aug. 25, 2022

(54) PNEUMATIC TIRE

(71) Applicant: The Yokohama Rubber Co., LTD., Tokyo (JP)

(72) Inventor: Sakiko MATSUMOTO, Kanagawa (JP)

(21) Appl. No.: 17/753,186

(22) PCT Filed: Aug. 25, 2020
(86) PCT No.: PCT/JP2020/032042

§ 371 Date: Feb. 23, 2022

(30) Foreign Application Priority Data
Aug. 27, 2019 (JP) 2019-154819

(51) Int. Cl. B60C 9/20; B60C 9/00

(52) U.S. Cl. CPC B60C 9/2003; B60C 9/0042; B60C 2009/0092; B60C 2009/2077; B60C 2009/2096; B60C 2009/2067; B60C 2009/2093

(57) ABSTRACT

In a pneumatic tire, a belt cover layer is provided on an outer circumferential side of a belt layer in a tread portion and includes organic fiber cords helically wound along a tire circumferential direction. As the organic fiber cord, a polyethylene terephthalate fiber cord is used which has a single yarn size fineness of 700 dtex or less and in which the number of twists is 30 twists or more/100 mm. A layer thickness of the belt cover layer is 1.6 times or more as large as a cord diameter of the organic fiber cord.

### TECHNICAL FIELD

The present technology relates to a pneumatic tire using polyethylene terephthalate (PET) fiber cords in a belt cover layer.

### BACKGROUND ART

Pneumatic tires for a passenger vehicle or a small truck typically include: a carcass layer mounted between a pair of bead portions, a plurality of belt layers disposed on an outer circumferential side of the carcass layer in a tread portion, and a belt cover layer disposed on an outer circumferential side of the belt layer, the belt cover layer including a plurality of organic fiber cords helically wound along a tire circumferential direction. In this structure, the belt cover layer mainly contributes to improvement of high-speed durability.

In the related art, the organic fiber cords used in the belt cover layer mainly include nylon fiber cords. However, the use of polyethylene terephthalate fiber cords (hereinafter referred to as PET fiber cords) has been proposed, which are more elastic and inexpensive than nylon fiber cords (for example, see Japan Unexamined Patent Publication No. 2001-63312). Furthermore, studies have been conducted about the use of PET fiber cords with low fineness for a reduction in tire weight. However, in a case where PET fiber cords with low fineness are simply used with the known structure of the tire unchanged, there has been a problem in that adhesion durability is degraded, making high-speed durability difficult to ensure. Thus, there has been a demand for a measure to favorably maintain adhesion durability to ensure high-speed durability when PET fiber cords with low fineness are used to reduce the tire weight.

### SUMMARY

The present technology provides a pneumatic tire that can favorably exhibit high-speed durability while reducing the tire weight, when PET fiber cords are used in a belt cover layer.

A pneumatic tire according to an embodiment of the present technology includes a tread portion extending in a tire circumferential direction and having an annular shape, a pair of sidewall portions respectively disposed on both sides of the tread portion, a pair of bead portions each disposed on an inner side of the sidewall portions in a tire radial direction, a carcass layer mounted between the pair of bead portions, a plurality of belt layers disposed on an outer circumferential side of the carcass layer in the tread portion, and a belt cover layer disposed on an outer circumferential side of the belt layers, the belt cover layer being formed by helically winding coating rubber-covered organic fiber cords along the tire circumferential direction, the organic fiber cord being a polyethylene terephthalate fiber cord having a single yarn size fineness of 700 dtex or less and in which a number of twists is 30 twists or more/100 mm, and a layer thickness G of the belt cover layer being 1.6 times or more as large as a cord diameter D of the organic fiber cord.

In the pneumatic tire according to an embodiment of the present technology, the belt cover layer is configured as described above, and thus, high-speed durability can be favorably exhibited with the tire weight reduced. In particular, the use of low fineness polyethylene terephthalate fiber cords (PET fiber cords) with a single yarn size fineness of 700 dtex or less enables a reduction in the weight of the belt cover layer, leading to a reduced tire weight. On the other hand, ensuring a sufficient number of twists of the organic fiber cords (PET fiber cords) lead to a structure with many recesses/protrusions on cord surfaces, allowing adhesion durability to be improved. In addition, properly increasing a layer thickness G of the belt cover layer with respect to a cord diameter D increases the proportion of rubber occupied in the belt cover layer, allowing adhesion durability to be improved. Adhesion durability thus improved enables prevention of separation between the belt layer and the belt cover layer at high speeds, allowing high-speed durability to be improved.

In an embodiment of the present technology, the organic fiber cord preferably comprises two or three plies intertwined. Reducing the number of plies in this manner is advantageous in reducing the tire weight.

In the present technology, the organic fiber cord preferably has an intermediate elongation of 3.5% or less under a 2.0 cN/dtex load. Setting the intermediate elongation in this manner allows cord rigidity to be ensured, and this is advantageous in improving high-speed durability.

In an embodiment of the present technology, the cord diameter D of the organic fiber cord and spacing S between the organic fiber cords adjacent to each other in the belt cover layer preferably have a relationship 1.0≤S/D≤1.5. Such a structure enables the amount of rubber between the cords to be properly ensured to improve adhesion durability, allowing more excellent high-speed durability to be obtained.

### BRIEF DESCRIPTION OF DRAWINGS

FIG. 1 is a meridian cross-sectional view illustrating a pneumatic radial tire according to an embodiment of the present technology.

FIG. 2 is an enlarged explanatory diagram illustrating a belt cover layer according to an embodiment of the present technology.

### DETAILED DESCRIPTION

Configurations of embodiments of the present technology will be described in detail below with reference to the accompanying drawings.

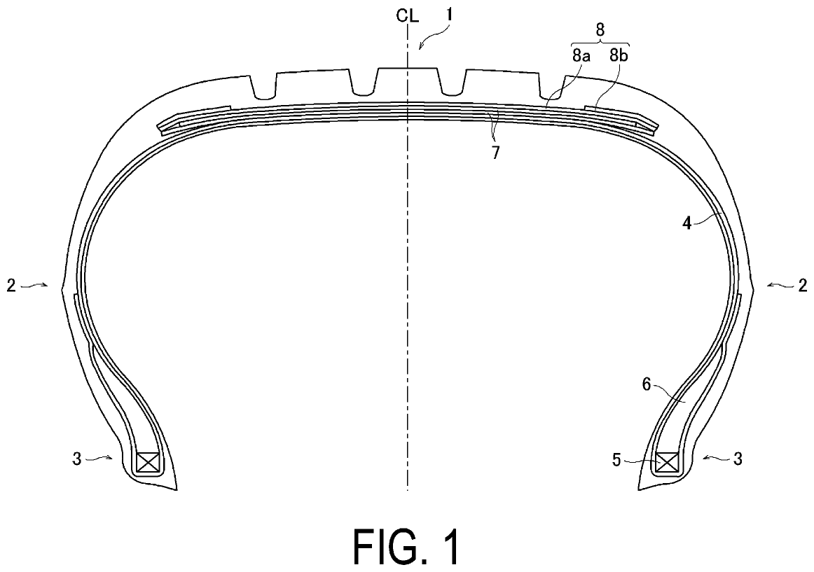

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords extending in the tire radial direction are mounted between the pair of left and right bead portions 3. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4. For example, polyester fiber cords are preferably used as the reinforcing cords of the carcass layer 4.

A plurality (in the illustrated example, two layers) of belt layers 7 are embedded on an outer circumferential side of the carcass layer 4 in the tread portion 1. The belt layers 7 each include a plurality of reinforcing cords inclining with respect to the tire circumferential direction, and are disposed such that the reinforcing cords of the different layers intersect each other. In these belt layers 7, the inclination angle of the reinforcing cords with respect to the tire circumferential direction is set in a range of, for example, 10° or more and 40° or less. For example, steel cords are preferably used as the reinforcing cords of the belt layers 7.

To improve high-speed durability, a belt cover layer 8 is provided on an outer circumferential side of the belt layers 7. The belt cover layer 8 includes organic fiber cords oriented in the tire circumferential direction. In the belt reinforcing layer 8, the angle of the organic fiber cords with respect to the tire circumferential direction is set, for example, to from 0° to 5°. In an embodiment of the present technology, the belt cover layer 8 necessarily includes a full cover layer 8a that covers the entire region of the belt layers 7, and can be configured to include a pair of edge cover layers 8b that locally cover both end portions of the belt layers 7 as necessary (in the illustrated example, including both the full cover layer 8a and the edge cover layers 8b). The belt cover layer 8 is preferably configured such that a strip material made of at least a single organic fiber cord bunched and covered with coating rubber is wound helically in the tire circumferential direction, and desirably has, in particular, a jointless structure.

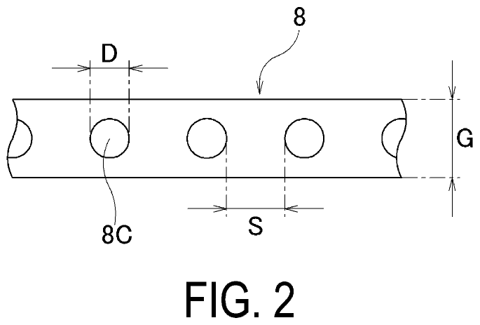

In the present technology, the organic fiber cords constituting the belt cover layer 8 are polyethylene terephthalate fiber cords (PET fiber cords), the single yarn size fineness is 700 dtex or less and preferably from 400 dtex to 600 dtex, and the number of twists is 30 twists or more/100 mm and preferably from 30 twists/100 mm to 41 twists/100 mm. Also, as illustrated in FIG. 2, assuming that the layer thickness (rolling gauge) of the belt cover layer 8 is G and the cord diameter of an organic fiber cord 8C is D, the layer thickness G of the belt cover layer 8 is set 1.6 times or more, preferably from 1.60 times or more to 1.80 times or more, and more preferably from 1.70 times or more to 1.8 times or more as large as the cord diameter D of the organic fiber cord 8C.

In an embodiment of the present technology, the use of low fineness PET fiber cords with a single yarn size fineness of 700 dtex or less as described above enables a reduction in the weight of the belt cover layer 8, reducing the weight of the tire. On the other hand, the number of twists of the PET fiber cords is 30 twists or more/100 mm, and thus, the structure includes many recesses/protrusions on cord surfaces, allowing adhesion durability to be improved. In addition, the number of twists is increased in the low fineness PET fiber cords with a single yarn size fineness in the range described above, and thus, the cords have a good structure (the degree of twist), allowing good fatigue resistance to be ensured. Furthermore, the layer thickness G of the belt cover layer 8C is properly large with respect to the cord diameter D, and thus the proportion of rubber occupied in the belt cover layer 8 increases, allowing adhesion durability to be improved. Adhesion durability thus improved enables prevention of separation between the belt layer 7 and the belt cover layer 8 at high speeds, thus allowing excellent high-speed durability to be obtained.

At this time, when the organic fiber cord (PET fiber cord) has a single yarn size fineness of more than 700 dtex, the effect of reducing the tire weight is not sufficiently produced. When the number of twists of the PET fiber cords is less than 30 twists/100 mm, sufficient recesses/protrusions fail to be formed on the cord surfaces, thus preventing adhesion durability from being improved and thus degrading high-speed durability. In addition, when the single yarn size fineness and the number of twists are outside the ranges described above, the degree of twist is lessened, and the fatigue resistance of the cords may be reduced. When the layer thickness G of the belt cover layer 8 is less than 1.6 times as large as the cord diameter D of the organic fiber cord, a sufficient amount of rubber fails to be ensured, and the effect of improving adhesion durability is limited, preventing high-speed durability from being improved. Note that an excessively increased layer thickness G of the belt cover layer 8 may offset the effect of weight reduction using low fineness cords and thus that in the relationship between the layer thickness G and the cord diameter D described above, the layer thickness G of the belt cover layer 8 is preferably from 0.62 mm to 0.70 mm, and more preferably from 0.65 mm to 0.70 mm.

The organic fiber cord (PET fiber cords) are formed by intertwining a plurality of plies, but the number of plies is preferably two or three. At this time, the total fineness of the organic fiber cords (PET fiber cords) is preferably 2100 dtex or less, and more preferably 800 dtex to 1750 dtex. Reducing the number of plies and the total fineness of the plies in this manner is advantageous in reducing the tire weight.

The organic fiber cord (PET fiber cord) preferably has an intermediate elongation of 3.5% or less, and more preferably from 3.0% to 3.5% under a 2.0 cN/dtex load. Setting the intermediate elongation in this manner allows cord rigidity to be ensured, and this is advantageous in improving high-speed durability. When the organic fiber cord has an intermediate elongation of more than 3.5% under a 2.0 cN/dtex load, sufficient cord rigidity fails to be ensured, limiting the effect of improving high-speed durability. Note that the “intermediate elongation under a 2.0 cN/dtex load” is an elongation ratio (%) of a sample cord measured under a 2.0 cN/dtex load by conducting a tensile test in accordance with JIS-L1017 “Test methods for chemical fiber tire cords” with length of specimen between grips being 250 mm and tensile speed being 300±20 mm/minute.

As illustrated in FIG. 2, assuming that the cord diameter of the organic fiber cord 8C is D and the spacing between the organic fiber cords 8C adjacent to each other in the tire width direction in the belt cover layer 8 is S, the cord diameter D and the spacing S preferably satisfy the relationship 1.0≤S/D≤2.0, and more preferably 1.1≤S/D≤1.9. Such a structure allows a proper amount of rubber to be provided between the cords, and this is advantageous in improving adhesion durability. In a case where the cord diameter D and the spacing S do not satisfy the relationship described above, a relatively small spacing S prevents a sufficient amount of rubber from being provided between the cords and degrading adhesion durability, and a relatively small cord diameter D makes the cord likely to be broken, making durability difficult to ensure.

In a case where polyethylene terephthalate fiber cords (PET fiber cords) are used as the organic fiber cords constituting the belt cover layer 8, the PET fiber cords preferably have a heat shrinkage stress of 0.6 cN/tex or more at 100° C. Setting the heat shrinkage stress at 100° C. as described above allows high-speed durability to be improved with the durability of the pneumatic tire maintained more effectively. When the heat shrinkage stress of the PET fiber cords at 100° C. is less than 0.6 cN/tex, the hoop effect when traveling cannot be sufficiently improved, and it is difficult to sufficiently maintain high-speed durability. The upper limit value of the heat shrinkage stress of the PET fiber cords at 100° C. is not particularly limited, but is preferably, for example, 2.0 cN/tex. Note that in an embodiment of the present technology, the heat shrinkage stress (cN/tex) at 100° C. is heat shrinkage stress of a sample cord, which is measured with reference to “Test methods for chemical fiber tire cords” of JIS (Japanese Industrial Standard)-L1017 and when heated under the conditions of the sample length of 500 mm and the heating condition at 100° C. for 5 minutes.

In order to obtain the PET fiber cords having the aforementioned physical properties, for example, it is preferable to optimize dip processing. In other words, before a calendar process, dip processing with adhesive is performed on the PET fiber cords; however, in a normalizing process after a two-bath treatment, it is preferable that an ambient temperature is set within the range of 210° C. to 250° C. and cord tension is set in the range of 2.2×10⁻² N/tex to 6.7×10⁻² N/tex. Accordingly, desired physical properties as described above can be imparted to the PET fiber cords. When the cord tension in the normalizing process is smaller than 2.2×10⁻² N/tex, cord elastic modulus is low, and thus the mid-range frequency road noise cannot be sufficiently reduced. In contrast, when the cord tension is greater than 6.7×10⁻² N/tex, cord elastic modulus is high, and thus fatigue resistance of the cords is low.

### EXAMPLES

Tires according to Conventional Example 1, Comparative Examples 1 to 4, and Examples 1 to 10 were manufactured. The tires have a tire size of 195/65R15, have a basic structure illustrated in FIG. 1, and vary in, as indicated in Tables 1 and 2, the single yarn size fineness of the organic fiber cords constituting the belt cover layer, the number of plies constituting the organic fiber cords (twist count), the wire density of the organic fiber cords in the belt cover layer (number of ends), the layer thickness G of the belt cover layer, the cord diameter D of the organic fiber cord, the cord spacing S between the organic fiber cords adjacent to each other in the tire width direction in the belt cover layer, the ratio G/D of the layer thickness G to the cord diameter D, the ratio S/D of the cord spacing S to the cord diameter D, the number of twists of the organic fiber cords, and the intermediate elongation of the organic fiber cord under a 2.0 cN/dtex.

In any of the examples, the belt cover layer is provided with only one full cover layer, and has a jointless structure in which a strip made of one organic fiber cord (PET fiber cord) bunched and covered with coating rubber is wound helically in the tire circumferential direction. Additionally, in each example, the intermediate elongation was measured by conducting a tensile test in accordance with JIS-L1017 “Test methods for chemical fiber tire cords” with length of specimen between grips being 250 mm and tensile speed being 300±20 mm/minute.

The test tires were evaluated for the weight of the belt cover layer, high-speed durability, and a breakage pattern of the tire after the high-speed durability test according to the following evaluation methods, and the results of the evaluation are indicated in Tables 1 and 2.

### Weight of Belt Cover Layer

The weight of the belt cover layer was calculated from the weight of the organic fiber cords and the rubber layer used in each test tire. Evaluation results are expressed as index values with Conventional Example 1 being assigned the index value of 100. Smaller index values mean lighter weight of the belt cover layer.

### High-Speed Durability

The test tires were mounted on wheels having a rim size of 15×7J, inflated with oxygen to an internal pressure of 230 kPa, and held for 30 days in a chamber maintained at a chamber temperature of 70° C. and a humidity of 95%. The pre-treated test tires in this manner were mounted on a drum testing machine with a drum with a smooth steel surface and a diameter of 1707 mm, and the ambient temperature was controlled to 38±3° C., the speed was increased from 120 km/h in increments of 10 km/h every 20 minutes, and the running distance until failure occurred in the tire was measured. The evaluation results are expressed as index values using measurement values of the running distance, with Conventional Example 1 being assigned an index value of 100. Larger index values mean a longer running distance before failure occurs and superior high-speed durability even after hygrothermal aging. Index values of “90” or more mean achievement of practically sufficient high-speed durability.

### Breakage Pattern

After the high-speed durability test described above was conducted, each of the test tires was disassembled, and the condition of failure (breakage pattern) in the belt cover layer was visually checked. The evaluation results were indicated as follows in A to D.

A: Separation occurred at the interface between the cord and the rubber in the tread portion.

B: Separation occurred between the belts.

C: Breakage was caused by fatigue of the organic fiber cords constituting the belt cover layer.

D: Separation occurred between the belt layer and the belt cover layer.

TABLE 1

| | | Conventional | Comparative | Comparative | Comparative | |
|---|---|---|---|---|---|---|
| | | Example 1 | Example 1 | Example 2 | Example 3 | |
| Single yarn size | dtex | 1100 | 1100 | 550 | 550 | |
| fineness | | | | | | |
| Twist count | cords | 2 | 2 | 2 | 2 | |
| Number of ends | cords/50 | 30 | | 30 | 60 | |
| | mm | | | | | |
| Layer thickness G | mm | 0.83 | 0.83 | 0.59 | 0.59 | |
| Cord diameter D | mm | 0.55 | 0.55 | 0.39 | 0.39 | |
| Cord spacing S | mm | 1.12 | 1.12 | 0.44 | 0.44 | |
| G/D | parts by | 1.51 | 1.51 | 1.51 | 1.51 | |
| | mass | | | | | |
| S/D | parts by | 2.03 | 2.03 | 1.14 | 1.14 | |
| | mass | | | | | |
| Number of twists | twists/100 | 26 | 38 | 26 | 38 | |
| | mm | | | | | |
| Intermediate | % | 3.5 | 4.2 | 2.8 | 3.5 | |
| elongation | | | | | | |
| Mass of belt | index | 100 | 101 | 71 | 73 | |
| cover layer | value | | | | | |
| High-speed | index | 100 | 90 | 85 | 95 | |
| durability | value | | | | | |
| Breakage pattern | | A | B | C | D | |
| | | Example | Example | Example | Example | Example |
| | | 1 | 2 | 3 | 4 | 5 |
| Single yarn size | dtex | 550 | 550 | 550 | 550 | 550 |
| fineness | | | | | | |
| Twist count | cords | 2 | 2 | 2 | 2 | 2 |
| Number of ends | cords/50 mm | 60 | 40 | 45 | 65 | 70 |
| Layer thickness G | mm | 0.67 | 0.67 | 0.67 | 0.67 | 0.67 |
| Cord diameter D | mm | 0.39 | 0.39 | 0.39 | 0.39 | 0.39 |
| Cord spacing S | mm | 0.44 | 0.86 | 0.72 | 0.38 | 0.32 |
| G/D | parts by mass | 1.72 | 1.72 | 1.72 | 1.72 | 1.72 |
| S/D | parts by mass | 1.14 | 2.21 | 1.85 | 0.97 | 0.83 |
| Number of twists | twists/100 mm | 38 | 38 | 38 | 38 | 38 |
| Intermediate | % | 3.5 | 3.5 | 3.5 | 3.5 | 3.5 |
| elongation | | | | | | |
| Mass of belt cover | index value | 82 | 82 | 82 | 82 | 82 |
| layer | | | | | | |
| High-speed | index value | 105 | 90 | 100 | 95 | 85 |
| durability | | | | | | |
| Breakage pattern | | B | B | B | A | A |

TABLE 2

| | | Comparative | Example | Example | Example | Example | Example |
|---|---|---|---|---|---|---|---|
| | | Example 4 | 6 | 7 | 8 | 9 | 10 |
| Single yarn | dtex | 550 | 550 | 550 | 550 | 550 | 550 |
| size fineness | | | | | | | |
| Twist count | cords | 2 | 2 | 2 | 2 | 2 | 2 |
| Number of ends | cords/ | 60 | 60 | 60 | 60 | 60 | 60 |
| | 50 mm | | | | | | |
| Layer thickness G | mm | 0.67 | 0.67 | 0.67 | 0.67 | 0.67 | 0.67 |
| Cord diameter D | mm | 0.39 | 0.39 | 0.39 | 0.39 | 0.39 | 0.39 |
| Cord spacing S | mm | 0.34 | 0.34 | 0.34 | 0.34 | 0.34 | 0.34 |
| G/D | parts by | 1.72 | 1.72 | 1.72 | 1.72 | 1.72 | 1.72 |
| | mass | | | | | | |
| S/D | parts by | 1.14 | 1.14 | 1.14 | 1.14 | 1.14 | 1.14 |
| | mass | | | | | | |
| Number of | twists/ | 25 | 30 | 35 | 38 | 41 | 45 |
| twists | 100 mm | | | | | | |
| Intermediate | % | 2.9 | 3.0 | 3.3 | 3.5 | 3.7 | 3.9 |
| elongation | | | | | | | |
| Mass of belt | index | 81 | 81 | 82 | 82 | 83 | 83 |
| cover layer | value | | | | | | |
| High-speed | index | 85 | 100 | 105 | 105 | 105 | 105 |
| durability | value | | | | | | |
| Breakage | | C | A | A | B | B | B |
| pattern | | | | | | | |

As can be seen from Tables 1 and 2, in contrast to the reference Conventional Example 1, the tires of Examples 1 to 10 allowed a reduction in the weight of the belt cover layer and achieved good high-speed durability even after hygrothermal aging. In addition, the breakage pattern after the high-speed durability test (breaking test) in Examples 1 to 10 was the same as the breakage pattern of the pneumatic tires (Conventional Example 1 and Comparative Example 1) provided with a belt cover layer using a conventional common single yarn size fineness organic fiber cords, indicating that the use of low fineness cords produced no adverse effect.

On the other hand, Comparative Example 1 had a large single yarn size fineness, thus producing no effect of reducing the weight of the belt cover layer. In Comparative Example 2, low fineness cords were used, but both the number of twists and the ratio S/D were small, leading to degraded high-speed durability. In addition, a non-preferable breakage pattern occurred after the high-speed durability test (breaking test). In Comparative Example 3, low fineness cords were used, but the ratio S/D was small, and thus, a non-preferable breakage pattern occurred after the high-speed durability test (breaking test). In Comparative Example 4, the number of twists of the organic fiber cords was small, preventing sufficient adhesion durability from being achieved and thus degrading high-speed durability. In addition, a non-preferable breakage pattern occurred after the high-speed durability test (breaking test).

1. A pneumatic tire comprising:
a tread portion extending in a tire circumferential direction and having an annular shape;
a pair of sidewall portions respectively disposed on both sides of the tread portion;
a pair of bead portions each disposed on an inner side of the sidewall portions in a tire radial direction;
a carcass layer mounted between the pair of bead portions;
a plurality of belt layers disposed on an outer circumferential side of the carcass layer in the tread portion; and
a belt cover layer disposed on an outer circumferential side of the belt layers,
the belt cover layer being formed by helically winding coating rubber-covered organic fiber cords along the tire circumferential direction,
the organic fiber cord being a polyethylene terephthalate fiber cord having a single yarn size fineness of 700 dtex or less and in which a number of twists is 30 twists or more/100 mm, and
a layer thickness G of the belt cover layer being 1.6 times or more as large as a cord diameter D of the organic fiber cord.

2. The pneumatic tire according to claim 1, wherein the organic fiber cord is formed by intertwining two or three plies.

3. The pneumatic tire according to claim 1, wherein the organic fiber cord has an intermediate elongation of 3.5% or less under a 2.0 cN/dtex load.

4. The pneumatic tire according to claim 1, wherein the cord diameter D of the organic fiber cord and a spacing S between the organic fiber cords adjacent to each other in the belt cover layer have a relationship 1.0≤S/D≤1.5.

5. The pneumatic tire according to claim 2, wherein the organic fiber cord has an intermediate elongation of 3.5% or less under a 2.0 cN/dtex load.

6. The pneumatic tire according to claim 5, wherein the cord diameter D of the organic fiber cord and a spacing S between the organic fiber cords adjacent to each other in the belt cover layer have a relationship 1.0≤S/D≤1.5.
